(19) United States
(12) Patent Application Publication
(10) Pub. No.: US 2013/0246306 A1
(43) Pub. Date: Sep. 19, 2013

(54) ACTIVE SHARE PORTFOLIO MONITORING, CALIBRATION, MANAGEMENT, AND FEE CALCULATION TOOL

(71) Applicants: Benjamin Maxwell Adams, Cleveland, OH (US); Anatole Pevnev, Westlake, OH (US)

(72) Inventors: Benjamin Maxwell Adams, Cleveland, OH (US); Anatole Pevnev, Westlake, OH (US)

(21) Appl. No.: 13/659,504

(22) Filed: Oct. 24, 2012

Related U.S. Application Data
(60) Provisional application No. 61/611,064, filed on Mar. 15, 2012.

(51) Int. Cl. G06Q 40/06

(52) U.S. Cl. CPC G06Q 40/06
USPC 705/36 R

(57) ABSTRACT

Systems and methods that facilitate monitoring and management of active funds are disclosed. These systems and methods can allow users to: (1) Accurately determine and monitor what portion of their investment is actively invested; (2) Properly compensate those managers based upon their level of active investment; (3) Define the specific level of active investment at which they want their investments managed; (4) Verify which index is being used to design and manage their active investment portfolio; and (5) Compare various indices to each other to fully understand which index best meets their investment objectives.

### CROSS-REFERENCE TO RELATED APPLICATIONS

This application claims the benefit of pending U.S. Provisional Patent application Ser. No. 61/611,064 (Atty. Dkt. No. 107701.1PRO) entitled “ACTIVE SHARE PORTFOLIO MONITORING, CALIBRATION, MANAGEMENT, AND FEE CALCULATION TOOL” and filed Mar. 15, 2012. The entirety of the above-noted application is incorporated by reference herein.

### BACKGROUND

Fund investors have two basic investment options when it comes to publicly traded securities; the first is to invest in a passive index fund that tracks a specific index (i.e., NASDAQ Composite, S&P 500, Wilshire 5000, etc.), while the second is to invest in an actively managed fund that may or may not be benchmarked to an index. This second group of investors is faced with a fundamental problem: while they compensate the advisor of their actively managed investment fund to manage those investments actively, they have no way to determine whether and to what extend the fund is being actively managed.

As a result, investors may not fully understand what they are receiving from their investment managers and, as a consequence, risk being overcharged for the services that they, in fact, are receiving.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in aspects thereof, can comprise systems or methods that facilitate active fund monitoring and management. Such a system can include a data acquisition component that can obtain information associated with an active fund and one or more indices. Additionally, such a system can include one or more of a monitoring component that can determine and/or monitor a measure of activity (e.g., Active Share Measure, etc.) associated with one or more funds; a fee calculation component that can determine an appropriate fee for the one or more funds (e.g., based on the measure of activity, etc.); a calibration component that can determine a calibrated or modified version of a fund, which can be based on an investor-specified level of active share management (e.g., a specified activity level, a specified multiplier (e.g., greater or less than 1) of the activity level of the underlying fund, etc.); a matching component that can identify one or more indices that an actively managed fund most closely resembles; or a comparison component that can compare two or more indices to each other.

In other aspects, the subject innovation can comprise one or more methods to determine and/or monitor a measure of activity (e.g., Active Share Measure, etc.) associated with one or more funds; to determine an appropriate fee for the one or more funds (e.g., based on the measure of activity, etc.); to determine a calibrated or modified version of a fund, which can be based on an investor-specified level of active share management (e.g., a specified activity level, a specified multiplier (e.g., greater or less than 1) of the activity level of the underlying fund, etc.); to identify one or more indices that an actively managed fund most closely resembles; or to compare two or more indices to each other.

In further aspects, the subject innovation can comprise a method that facilitates active investment. Such a method can include the steps of obtaining information associated with an active fund and one or more indices and determining a first active share measure of the active fund relative to a first index of the one or more indices. Additionally, such a method can also include steps for receiving a first target level of activity and determining a calibrated fund based at least in part on the active share measure and the first target level of activity.

In one or more other embodiments, the subject innovation can include a method of applying fees for active investment. Such embodiments can include the acts of monitoring data associated with an active fund and one or more indices and determining a first active share measure of the active fund relative to a first index of the one or more indices. Additionally, such a method can include the acts of receiving fee data comprising an active fee and a passive fee and calculating a fee for the active fund based at least in part on the active fee, the passive fee, and the first active share measure.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates active fund monitoring and management.

FIG. 2 illustrates a method of monitoring the active share measure on an ongoing basis.

FIG. 3 illustrates a method of determining and applying the appropriate fees based upon a fund's active share measure.

FIG. 4 illustrates a method of creating a portfolio calibrated to an investor specified level of active share management.

FIG. 5 illustrates a method of identifying which index an actively managed fund most closely resembles.

FIG. 6 illustrates a method of comparing one index to another.

FIG. 7 illustrates a block diagram of a computer operable to execute the disclosed architecture.

FIG. 8 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In various embodiments, the subject innovation provides systems and methods that employ a measure of the level of activity associated with an actively managed fund. Based on this measure, systems and methods of the subject innovation, in aspects, can: (1) Accurately determine and monitor what portion of their investment is actively invested; (2) Properly compensate those managers based upon their level of active investment; (3) Define the specific level of active investment at which they want their investments managed; (4) Manage a fund to select and/or maintain a target level of active investment; (5) Verify which index is being used to design and manage their active investment portfolio; or (6) Compare various indices to each other to fully understand which index best meets their investment objectives.

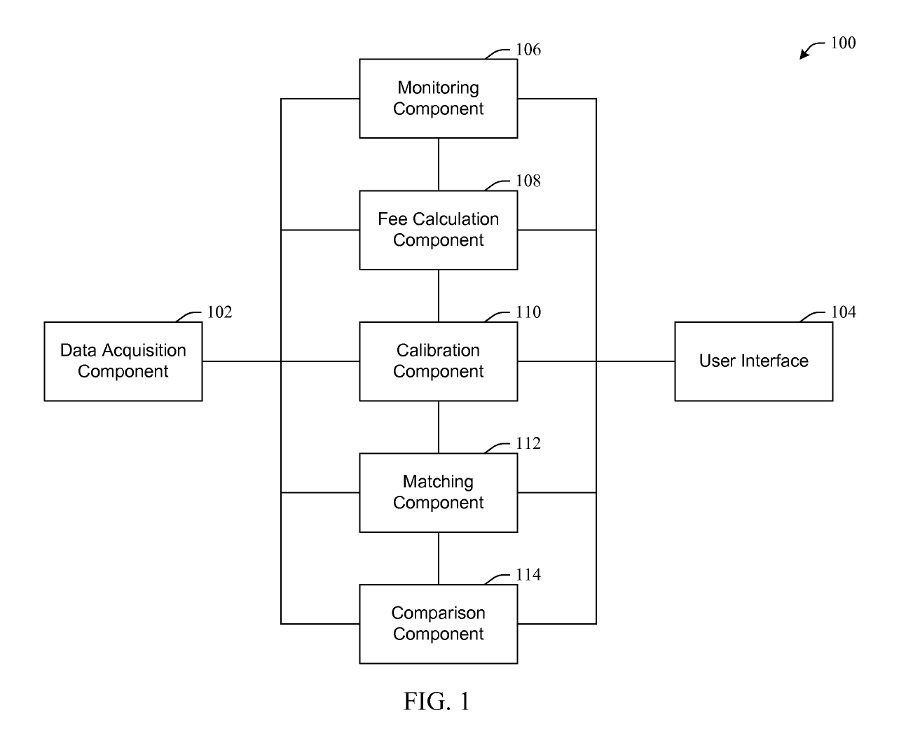

Referring initially to the drawings, FIG. 1 illustrates a system 100 capable of facilitating active fund monitoring and management. System 100 can include a data acquisition component 102 that can obtain information useable by system 100 from one or more local or remote sources, such as information associated with one or more indices and/or one or more active funds. This information can include information about a securities index (e.g., index constituent data, stock price data, etc.) or an active fund (e.g., fund holdings data, fund trading data, stock price data, etc.), user input via user interface 104 (e.g., user selections regarding indices or funds of interest, desired activity levels, etc.), or other components of system 100 (e.g., regarding weights, fee structures, etc.). Additionally, system 100 can include one or more of a monitoring component 106 that can determine, set, and/or monitor a measure of activity (e.g., Active Share Measure, etc.) associated with one or more funds; a fee calculation component 108 that can determine an appropriate fee for the one or more funds (e.g., based on the measure of activity, etc.); a calibration component 110 that can determine a calibrated or modified version of a fund, which can be based on an investor-specified level of active share management (e.g., a specified activity level, a specified multiplier (e.g., greater or less than 1) of the activity level of the underlying fund, etc.); a matching component 112 that can identify one or more indices that an actively managed fund most closely resembles; or a comparison component 114 that can compare two or more indices to each other.

Further, in various embodiments of the subject innovation, one or more of the components of system 100 need not be included. For example, in some aspects, the subject innovation can facilitate selection of a fund or funds to have a desired or target activity level (e.g., as determined by Active Share Measure, discussed herein), without the need to determine fees using methods discussed herein, and thus not necessitating inclusion of fee calculation component 108. Optionally, such embodiments can also adjust the activity level of the fund on an ongoing basis to maintain the target activity level, or to meet a new target activity level, if specified. In a second example, other embodiments may provide for the ability to determine an activity level of a fund whether or not it is managed to achieve a target activity level, and can determine appropriate fees based on the activity level of the fund; in these other embodiments, calibration component 110 need not be included. As will be apparent to a person of skill in the art in light of the teachings herein, in various embodiments different components of system 100 may be optional.

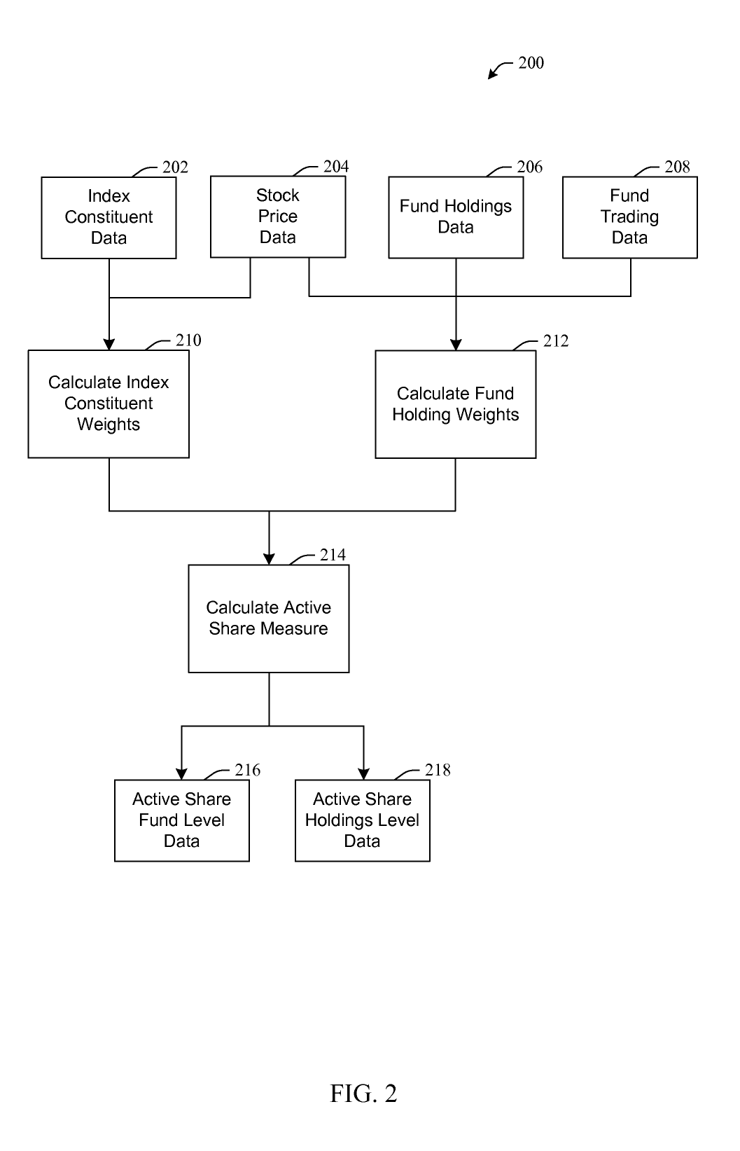

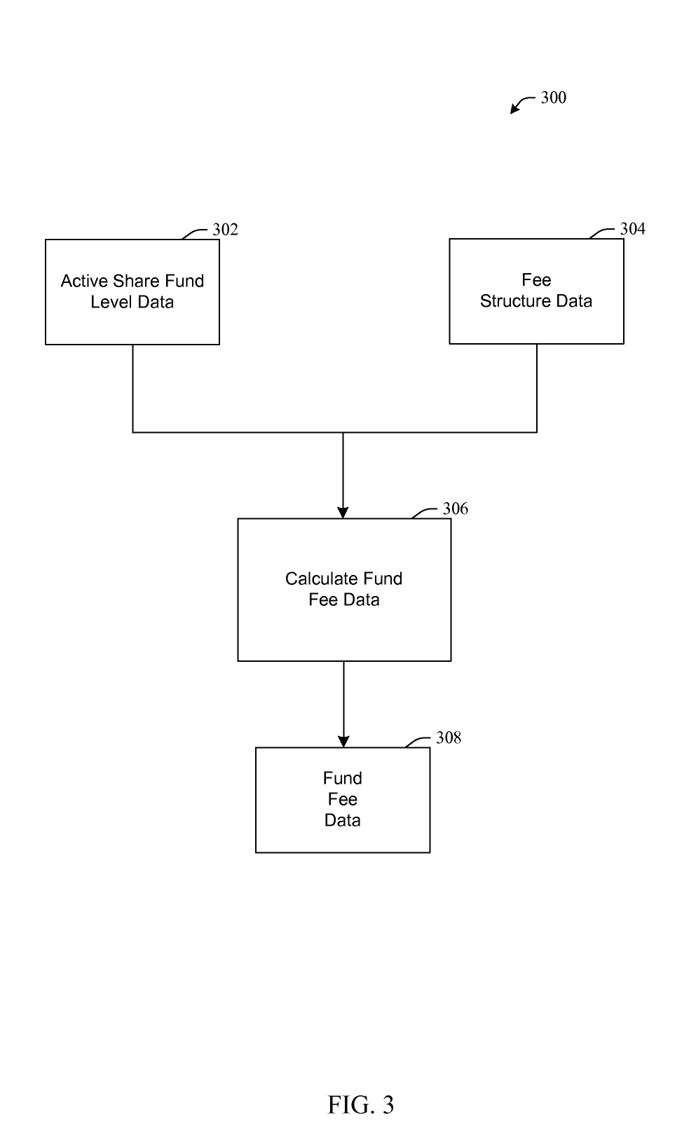

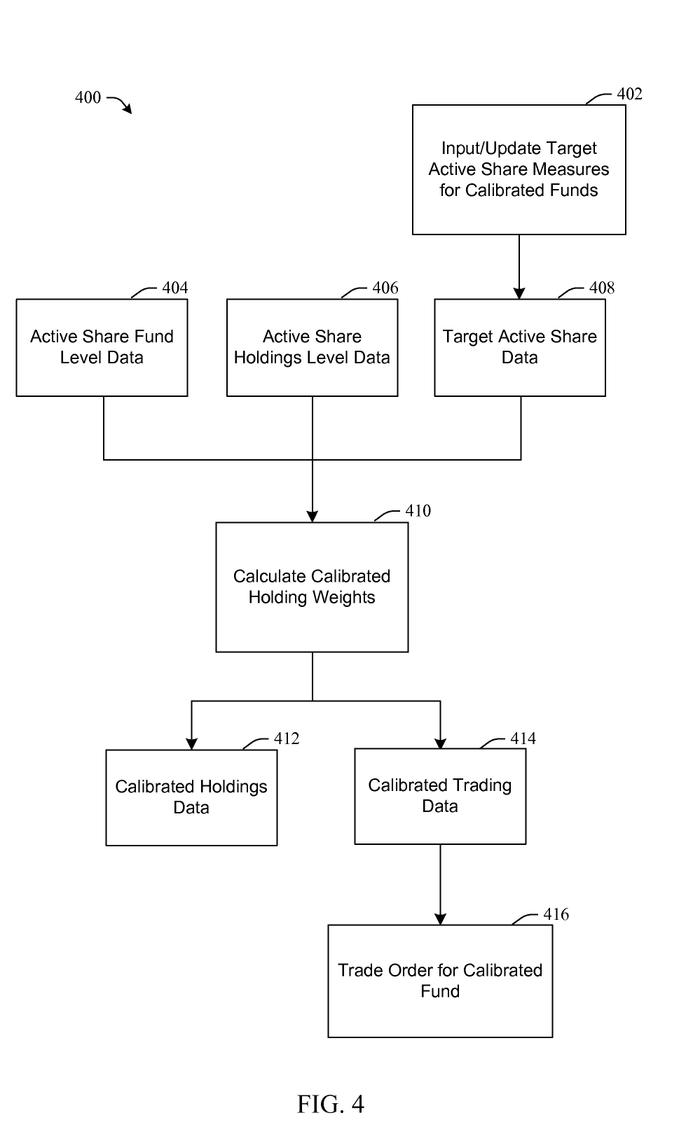

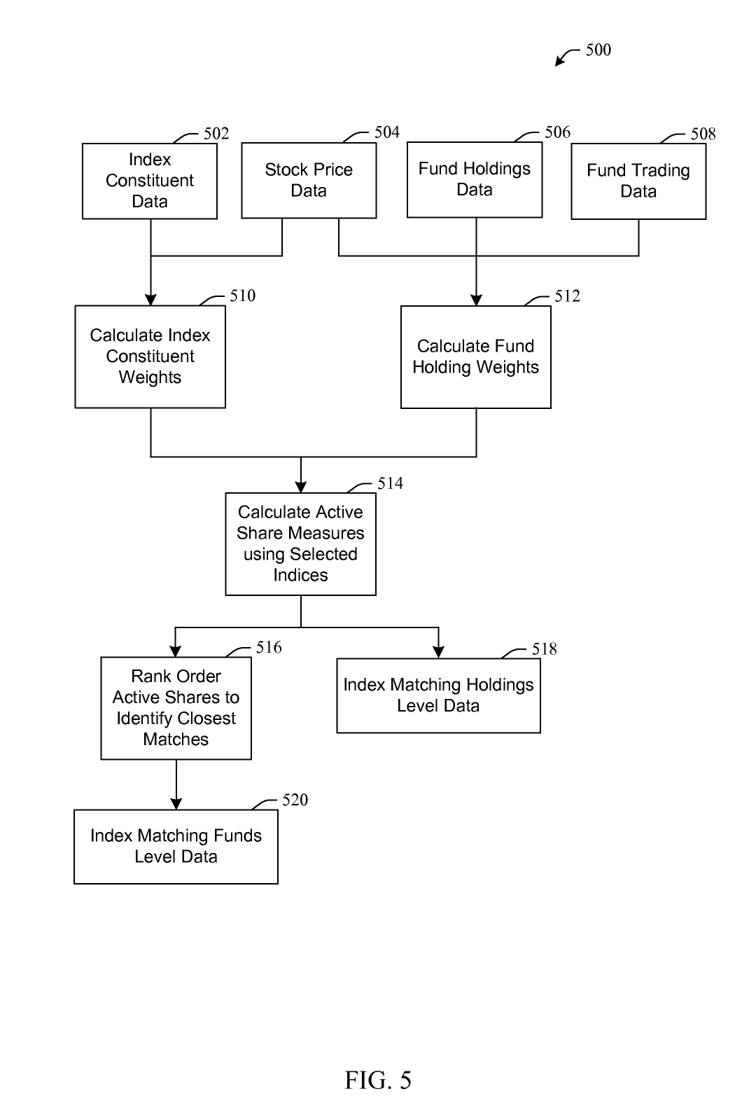

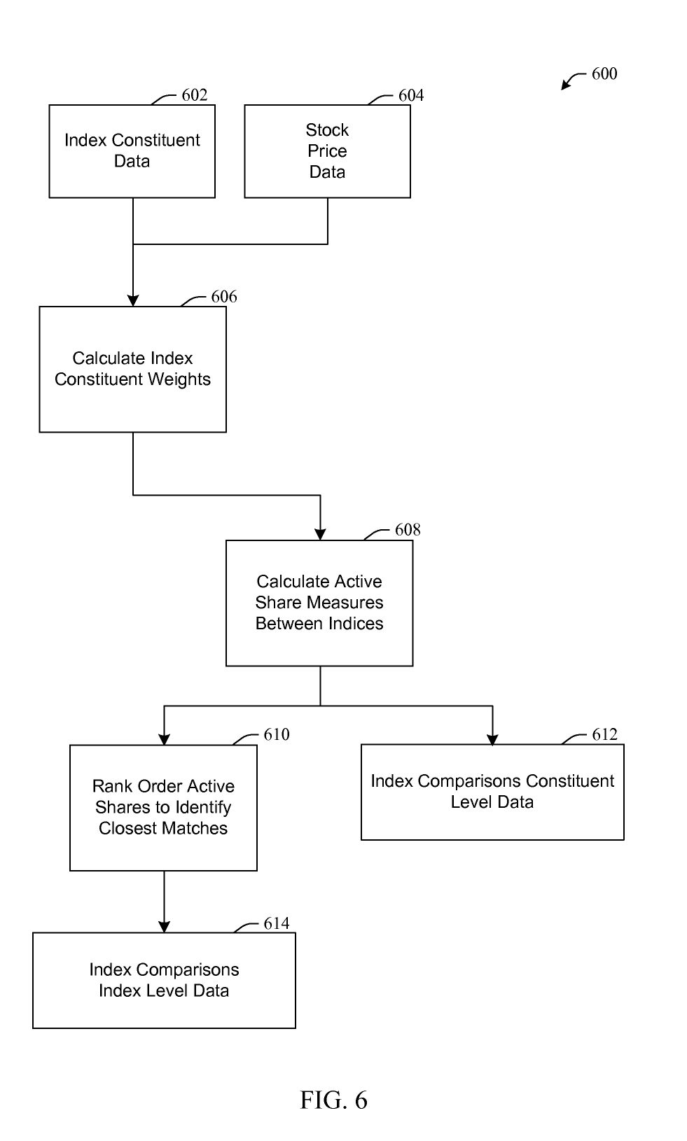

In some embodiments, additional aspects of components 106-114 are described herein with reference to FIGS. 2-6, the methods of which can be performed, respectively, by components 106-114. That is, in aspects, monitoring component 106 can perform the method illustrated in FIG. 2, fee calculation component 108 can perform the method illustrated in FIG. 3, calibration component 110 can perform the method illustrated in FIG. 4, matching component 112 can perform the method illustrated in FIG. 5, and/or comparison component 114 can perform the method illustrated in FIG. 6.

In various aspects, as a starting point, the subject innovation can determine the Active Share Measure as a measure of activity for a fund in question, according to equation (1):

$$Active Share Measure = \frac{1}{2} {\sum }_{i = 1}^{N} \vert {Weight}_{fund , i} - {Weight}_{index , i} \vert \qquad ( 1 )$$

where Active Share Measure is a measure of the level of active investment in a fund, Weight_{fund,i} is the fund's investment weight in security i (e.g., expressed in terms of a percentage, or a number in the domain [0,1] (or potentially greater or lesser, e.g., for some long or short positions), etc., with the sum of the fund's investment weights in securities totaling 1, 100%, etc.), and Weight_{index,i} is the index weight in security i (e.g., expressed in terms of a percentage, or a number in the domain [0,1] (or potentially greater or lesser, e.g., for some long or short positions), etc., with the sum of the index's investment weights in securities totaling 1, 100%, etc.). The constant ½ is included to normalize the Active Share Measure to the range [0,1], etc. Active Share Measure has previously been used to determine a fund manager's level of active investment at a given point in time.

Equation (1) alone, however, does not address the problems faced by investors that were listed above. While the equation calculates at some discrete point in time what the Active Share Measure of a fund is, it provides no mechanism for monitoring the level of active investment in the fund on an ongoing basis nor does it provide a mechanism for establishing fees based upon this measure. Moreover, prior discussions of Active Share Measure make no mention of the applications and extensions explained herein.

FIGS. 2-6 illustrate methodologies in accordance with various aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 2 illustrates a method 200 of monitoring the active share measure on an ongoing basis. While equation (1) allows calculation of a fund's active share measure at a discrete point in time without requiring an automated process, anything beyond this simple one-off analysis will require an automated process. At its most basic level, every time a fund manager trades a security in their portfolio, the active share measure for that portfolio changes. This could result in multiple recalculations on a daily basis in a single fund. By including corporate actions (dividend payments, stock issuance, stock splits, etc.), index constituent changes, or share price movements, the computational frequency and resultant computing requirements rise dramatically to a level that quickly exceeds human capacity for manual calculation. Accordingly, systems and methods of the subject innovation can be used to calculate the active share measure on a real time basis for monitoring purposes. These systems and methods can automate the flow of one or more of index constituent data, fund holdings data, fund trading data, stock price data, or fee structure data. In contrast, the number and type of calculations required, on a recurring basis, make manual calculation impossible for active investors.

With continued reference to FIG. 2, the method can begin by monitoring (e.g., on a real-time basis, etc.) one or more sources of data, such as index constituent data 202, stock price data 204, fund holdings data 206, or fund trading data 208. At 210, the index constituent weights can be calculated, based on one or more of the index constituent data 202 or the stock price data 204. Additionally, the fund holding weights can be calculated at 212, which can be based on at least one of stock price data 204, fund holdings data 206, or fund trading data 212. Based on the weights determined at 210 and 212, the Active Share Measure can be calculated at 214 (e.g., via equation (1)). From the calculated Active Share Measure, the method can determine one or more of active share fund level 216 data or active share holdings level data 218. These determinations can be provided in real-time, or with one or more historical measures (e.g., over a given time period, such as some number of hours, days, weeks, months, years, etc., e.g., the last hour, day, week, month, year, etc.). Further, although discussed in connection with a single index and fund, method 200 can also compare multiple indices to multiple funds on an individual fund to index basis, and this information can be presented in any of a variety of formats (e.g., a table comparing funds 1 through M to indices 1 through N, interactive formats, etc.).

Turning to FIG. 3, illustrated is a method 300 of determining and applying the appropriate fees based upon a fund's active share measure. In various aspects, the subject innovation can comprise a method of determining and assessing fees based upon a level of activity (e.g., Active Share Measure) of a fund. Based on a fund's active share measure, that information can be used to determine the appropriate fee to charge for that fund. While fund managers have traditionally charged a fixed fee (or some variant thereof) for their actively managed investment funds regardless of how closely those funds do, or do not, match the investments and investment weights of their underlying benchmark indices; the subject innovation can allow the calculation of fees based upon how active the investments in an investment fund truly are. When an investment fund has an active share measure of 0.0%, that fund would be considered fully passive and could receive a fee commensurate with other passively managed investment funds based on that underlying index. In contrast, when an investment fund has an active share measure of 100.0%, that fund would be considered fully active and could receive a fee commensurate with other actively managed funds based on that underlying index. For investment funds that fall between these two extremes, determining the fee that the manager should receive becomes a more complicated matter. While managers currently will charge an active fee on their fund, regardless of whether their fund has an active share measure of 90.0% or 10.0%, this does not accurately reflect the value that the manager is providing to the investor. The subject innovation can calculate and apply an appropriate fee for a specified time period that is based upon the manager's stated fees for a fully active fund and a fully passive fund. Those fees can be applied on a proportional basis that is determined by the fund's active share measure for the specified time period (e.g., as a weighted average of the active fund fee and the passive fund fee, weighted by the extent to which the fund is active or passive, respectively). For example, if a fund had an active share measure of 40.0%, the fee charged to the investor in that fund could be calculated according to equation (2):

$$Fund Fee = ⌈ \begin{matrix}( 1 - Active Share Measure ) \times \\ Passive Fee\end{matrix} ⌉ + [ \begin{matrix}Active Share Measure \times \\ Active Fee\end{matrix} ] \qquad ( 2 )$$

for the example given (an active share measure of 40.0%), the fee could be calculated as in example equation (3):

Fund Fee=[(1−0.4)×Passive Fee]+[0.4×Active Fee] (3)

where Fund Fee is the overall fee that can be charged to a fund investor based upon the Active Share Measure of a fund, as calculated in equation (1) above, the Passive Fee is the stated fee that would be assessed on a fully passive portfolio, and the Active Fee is the stated fee that would be assessed on a fully active portfolio. Method 300 can calculate the appropriate fees in real time, which can be applied or stored for later application (e.g., on a periodic basis, such as monthly, etc.). Determined activity level data (such as determined in accordance with the method of FIG. 2) can be used for fee setting as discussed herein in a variety of manners, such as based on a periodic or time-weighted basis. For example, if an activity level is determined at regular intervals (e.g., daily), the activity level for fee assessment can reflect the average of the values at each interval (e.g., if the Active Share Measure was 0.3 for 10 days in a month, and 0.6 for 20 days in a month, the Active Share Measure for the month could be 0.5: [(0.3*10 days)+(0.6*20 days)]/30 days=0.5). In another example, if the activity level is determined in real time, the activity level for fee assessment can be based on an average of the activity levels during the assessment period weighted by how long the fund had the given activity level (e.g., if a fund had an activity level of 0.1 for 3 hours and 0.2 for 24 hours, the 0.2 value would be weighted eight times as heavily as the 0.1 value for determining an average activity level for the fee assessment period). Alternatively, which can produce equivalent results in some aspects, fees can be calculated in real time or at intervals at which an activity level is determined (e.g., hourly, daily, etc.), and can be assessed at the same or different intervals (e.g., if calculated in real time or daily, etc., the calculated fees can be summed and assessed monthly, etc.).

With continued reference to figure FIG. 3, illustrated is an example flow of method 300. The active share fund level data 302 can be received or determined (e.g., according to method 200, etc.), and in combination with fee structure data 304 (e.g., set based upon the manager's stated fees, etc.), the fund fee data can be calculated at 306 (e.g., according to equation (2)). The fund fee data 308 can be provided to a user for reference, or to a billing system, etc.

FIG. 4 illustrates a method 400 of creating a portfolio calibrated to an investor specified level of active share management. While the active share measure provides a means for measuring how active an investment fund is at some discrete point in time, it does not provide a mechanism for creating investment funds tuned to a specified level of active investment. This specified level of active investment can either be a fixed value (such as 40.0% or 80.0%) or a multiple of the active share measure of the underlying investment fund (such as 0.5× or 2.0×). This specified level of active investment is referred to herein as the Target Active Share Measure. Equations (4)-(6) can be used to calculate the target investment weight for each security based upon the Target Active Share Measure, beginning with calculating the active weight for a given security in the original actively managed investment fund according to equation (4):

Weight_{active,i}=Weight_{fund,i}−Weight_{index,i} (4)

where Weight_{active,i} is the original fund's active weight in security i, Weight_{fund,i} is the fund's investment weight in security i, and Weight_{index,i} is the index weight in security i. Once this value has been calculated for all of the investments in the original fund, the target active weight for that security in a fund calibrated to the specified level of active investment can be calculated according to equation (5):

$$Target {Weight}_{active , i} = {Weight}_{active , i} \times ( \frac{Target Active Share}{Active Share Measure} ) \qquad ( 5 )$$

In equation (5), Target Weight_{active,i} is the calibrated fund's targeted active weight in security i, Weight_{active,i} is the original fund's active weight in security i as calculated above in equation (4), Active Share Measure is the level of active investment in the original fund as defined in equation (1) above, and Target Active Share is the specified level of active investment in the new calibrated fund. Based on the target weights determined according to equation (5), it is possible to calculate the target investment weight for an individual security in the calibrated fund, as shown in equation (6):

Target Weight_{fund,i}=Weight_{index,i}+Target Weight_{active,i} (6)

where Target Weight_{fund,i} is the calibrated fund's targeted investment weight in security i, Weight_{index,i} is the index weight in security i and Target Weigh_{active,i} is the calibrated fund's targeted active weight in security i, as defined in equation (5). Method 400 can facilitate the creation of calibrated portfolios that can use the investment selections of the original active investment fund as a starting point, or template, recalibrating the individual security weights to match the specified active investment level of the investor. Method 400 and systems employing it can also automatically provide trading instructions for the calibrated fund based upon any trades or changes in either the original fund or the index.

With continued reference to FIG. 4, method 400 can begin at 402, where target active share measures for one or more calibrated funds are received (e.g., as user input as initial selections, updates to preferences, or automatically based on a change in a fund's active share measure, such as when the specified active investment level is a multiplier of the active share measure, etc.). The active share fund level data 404 (e.g., as determined according to equation (1), etc.), active share holdings level data 406, and target active share data 408 can be determined. Next, at 410, the calibrated holding weights can be calculated based on the determined data. Based on the holding weights, calibrated holdings data 412 (e.g., holding levels of the calibrated fund, etc.) and calibrated trading data 414 (e.g., trades necessary to obtain the holding levels of the calibrated fund, etc.) can be determined. Finally, based on the calibrated trading data 414, one or more trade orders for the calibrated fund can be issued at 416.

In other aspects, one or more embodiments of the subject innovation can comprise a method such as method 400 that can be applied to investments in a plurality of funds. For example, if a fund includes two funds of differing activity levels, relative weighting of investment in those funds can be selected to achieve a target activity level (e.g., an Active Share Measure of 0.8, etc.). As a specific example, if a first fund allocates investment between an index and an active fund that tracks the index with an Active Share Measure of 1, and the Target Active Share Measure for the first fund is 0.8, then a weighting of 20% to the index and 80% to the active fund can achieve the Target Active Share Measure. In addition, however, continuing the example, if the active fund changes and its Active Share Measure is altered as a result, e.g., becoming 0.9, systems and methods of the subject innovation can provide for automatic reallocation of the ratio of investments between the index and the active fund to maintain the Target Active Share Measure of the first fund (e.g., in the example, a ratio of $8 in the active fund for every $1 in the index will provide the Target Active Share Measure). These adjustments to maintain the Target Active Share Measure can occur in real time in some embodiments, or can occur periodically in others. It follows that method 400 or a similar method can be used to maintain a specific Target Active Share Measure, and thus can enable systems and methods of the subject innovation to be calibrated to achieve a specific (e.g., significantly high) Target Active Share Measure in a first fund that matches an index investment alongside a high fund with a nonzero Active Share Measure to achieve a Target Active Share Measure for the first fund.

Turning to FIG. 5, illustrated is a method 500 of identifying which index an actively managed fund most closely resembles. While investment managers may state that their active investment fund is benchmarked to a given index (or no index at all), it may, in fact, more closely reflect the investment structure of another index. While this may be an innocent mistake on the part of the fund manager, it could also be a deliberate attempt on the part of the fund manager to deceive the investor as well as index providers. The deception of the investor on the part of the fund manager could be that the fund manager is attempting to be paid active management fees for what is essentially a passively managed portfolio. The deception of the index provider on the part of the fund manager may be that the fund manager is trying to avoid compensating the index provider for the use of their intellectual property. Regardless of whether there is any deception on the part of the fund manager, intentional or not, the subject innovation can compare any given active investment fund to some or all indices (e.g., in a database associated with a system or method of the subject innovation, etc.). These comparisons can be either point in time (a single date) or periodic (a range of dates). The subject innovation can quickly and easily make these comparisons and can present the collated results to the user. As such, embodiments of the subject innovation can quickly and accurately allow investors to identify the index or indices that any given active fund is tracking. In aspects, this data can be used to determine an activity level (e.g., Active Share Measure, etc.) for the index that the active fund most closely tracks. This activity level can be automatically determined from among the indices with which the active fund was compared, and can be used in various aspects of the subject innovation described herein (e.g., creating calibrated funds, fee setting, etc.).

With continued reference to FIG. 5, method 500 can proceed substantially as follows. One or more of index constituent data 502, stock price data 504, fund holdings data 506, or fund trading data 508 can be determined. Based on index constituent data 502 and stock price data 504, the index constituent weights can be calculated at 510 for two or more selected indices. The weights can be calculated relative to the union of the sets of constituents of each of the indices (e.g., if index one has securities A, B, and C, and index two has securities B, C, D, and E, weights can be calculated for both relative to potential constituents A, B, C, D, and E). Next, at 512, the fund holding weights can be calculated based on the stock price data 504, fund holdings data 506, and fund trading data 508. The active share measures of the fund relative to each of the selected indices can be calculated at 514 (e.g., as described in connection with equation (1), etc.). Next, at 516, one or more indices that the fund most closely tracks can be identified, such as by rank ordering the active share measures of the indices. Additionally, index matching holdings level data 518 can be determined, which can be provided to a user to assist comparisons, stored, etc. Also, index matching fund level data 520 can be determined and/or provided.

FIG. 6 illustrates a method 600 of comparing one index to another. Systems and methods of the subject innovation can provide for objective comparisons of indices to one another, which can facilitate investor selection of one or more indices for investment purposes. Investors are often faced with having to decide which of a group of indices they should use as a benchmark for their investments. While investors prefer to make this decision based upon objective information about the indices, this typically becomes a subjective decision driven by the fact that there is limited information available to highlight the similarities and the differences between the indices. By comparing the active share measure of a group of indices to each other, the subject innovation can clearly show the location and the level of similarities and differences between the various indices. Embodiments of the subject innovation can provide users with the capability to make these comparisons on an “as needed” basis, a recurring basis, as well as over specified periods. Systems and methods of the subject innovation can also allow users to compare indices at either a high level (e.g., how “active” is one index when compared to another?) or at a detailed level (e.g., what are the individual securities that distinguish one index from another and how do they differ?).

Method 600 can begin by determining index constituent data 602 and stock price data 604 for two or more indices. Next, at 606, index constituent weights can be determined for each of the two or more indices. Based on the determined information, the active share measures of the two or more indices can be determined relative to one another at 608. For a given index, at 610, one or more closest matches can be determined based on the active share measures of the other index or indices, such as by rank ordering the other index or indices. Additionally, index comparisons constituent level data 612 and index comparisons index level data 614 can be determined, and can be provided to a user, stored, etc.

Systems and methods of the subject innovation can be implemented in a variety of forms, such as an internet application accessible via common web browsers, a locally installed application on a user's computer, a mobile application or “app,” etc. The data structures, functionality, and user interface can be similar, or can be tailored in one or more ways to facilitate access via the specific form (e.g., input and output devices such as touch screens, keyboards, etc.). Users can be provided with multiple options to customize interaction and presentation of information, such as setting data update and recalculation frequencies ranging from real-time (or continuous) to annual, and all frequencies in between.

While the disclosure herein provides multiple embodiments and methods, in aspects, these can all be interrelated and share the same basic underlying data feeds, and various embodiments can incorporate any or all of the features discussed herein. For example, some embodiments can read in (1) Index constituent (or holdings) data; (2) Fund holdings data; (3) Fund trading data; (4) Stock price data; and (5) Fee structure data. Two of these data feeds (index constituent data and stock price data) can, in aspects, be provided by third parties and can be made available as an integrated part of the tool. The other three data feeds (fund holdings data, fund trading data, and fee structure data) can either be user provided or can be provided by a third party.

As items are calculated and processed in embodiments of the subject innovation, the results can be retained in an underlying database so that they will be made available to other components or methods of the subject innovation. For example, when the active share measure for a fund is calculated within method 200, that data can be retained so that appropriate fees may be calculated for that fund in method 300. That data can then be available to other components or methods of the subject innovation.

In some aspects, users can interact with the innovation via a simple and clean computer interface. The interface can facilitate user selection and modification of the available options as needed. The interface can also allow the user to view any or all data used in connection with the innovation. In aspects, the interface can allow the user to view results on screen, both as text and data as well as graphs. The interface can additionally allow the user to generate reports using one or more of the text, data, and graphs provided by the innovation. These can be saved or printed to any of a number of standard formats (i.e., JPG, PDF, CSV, TXT, Word, Excel, etc.). The interface can further allow the user to generate trade tickets (electronically or in hard copy) that can be used to initiate the trades that are suggested by the subject innovation.

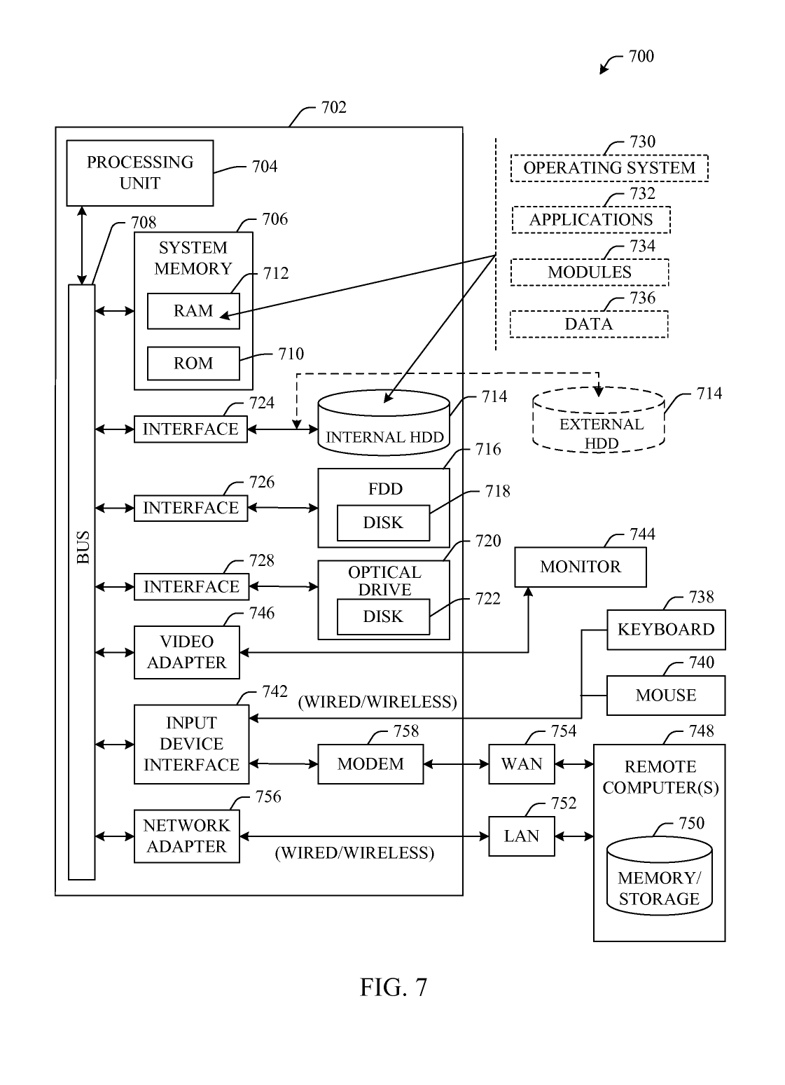

Referring now to FIG. 7, there is illustrated a block diagram of a computer operable to execute the disclosed architecture. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

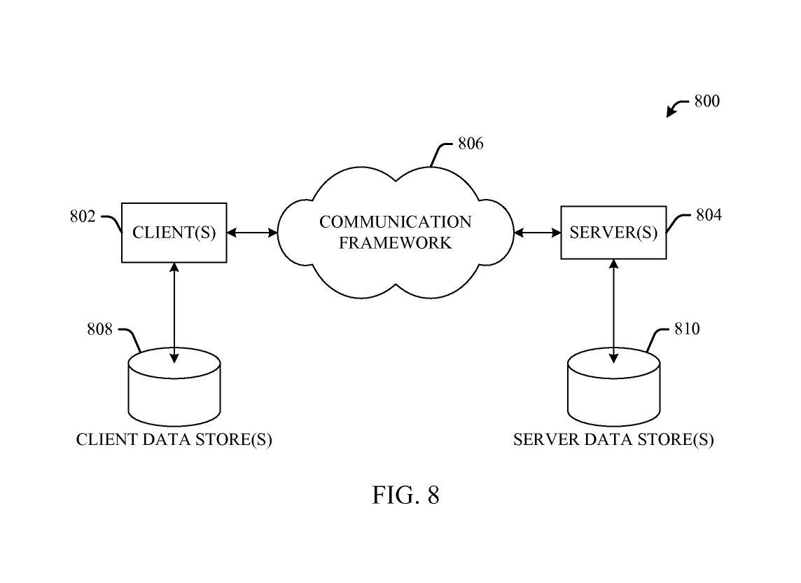

Referring now to FIG. 8, there is illustrated a schematic block diagram of an exemplary computing environment 800 in accordance with the subject innovation. The system 800 includes one or more client(s) 802. The client(s) 802 can be hardware and/or software (e.g., threads, processes, computing devices). The client(s) 802 can house cookie(s) and/or associated contextual information by employing the innovation, for example.

The system 800 also includes one or more server(s) 804. The server(s) 804 can also be hardware and/or software (e.g., threads, processes, computing devices). The servers 804 can house threads to perform transformations by employing the innovation, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates monitoring and management of an active fund, comprising:
a data acquisition component that obtains information associated with an active fund and with one or more indices; and
a monitoring component that determines and monitors at least one active share measure of the active fund relative to at least one of the one or more indices.

2. The system of claim 1, further comprising a fee calculation component that determines an appropriate fee for the active fund based at least in part on the at least one active share measure.

3. The system of claim 2, wherein the fee calculation component determines the appropriate fee for the active fund based at least in part on a weighted average of a passive fee and an active fee.

4. The system of claim 1, further comprising a calibration component that determines a calibrated fund based at least in part on the active share measure and a specified level of activity.

5. The system of claim 4, wherein the calibrated fund comprises a plurality of securities and the calibration component determines target weights for each of the plurality of securities of the calibrated fund based at least in part on the ratio of the specified level of activity and the active share measure.

6. The system of claim 4, wherein the calibration component automatically generates one or more trade tickets based at least in part on the determined calibrated fund.

7. The system of claim 4, wherein the calibrated fund comprises investments in both the active fund and the at least one of the one or more indices, and the calibration component allocates investment between the active fund and the at least one of the one or more indices such that an active share measure of the calibrated fund is equal to the specified level of activity.

8. The system of claim 1, further comprising a matching component that identifies an index of the one or more index that the active fund most closely resembles.

9. The system of claim 1, wherein the one or more indices comprises two or more indices, and the system further comprises a comparison component that compares at least two of the two or more indices to one another based at least in part on an index active share measure.

10. A method that facilitates active investment, comprising:
obtaining information associated with an active fund and one or more indices;
determining a first active share measure of the active fund relative to a first index of the one or more indices;
receiving a first target level of activity; and
determining a calibrated fund based at least in part on the active share measure and the first target level of activity.

11. The method of claim 10, further comprising:
receiving a second target level of activity;
determining one or more adjustments to the calibrated fund based at least in part on the active share measure and the second target level of activity.

12. The method of claim 11, further comprising automatically generating one or more trade tickets based at least in part on the one or more adjustments.

13. The method of claim 10, wherein the calibrated fund comprises an active investment in the active fund and a passive investment in the first index, and wherein the ratio of the quantity of active investment to the quantity of passive investment is based at least in part on the first active share measure and the first target level of activity.

14. The method of claim 10, further comprising:
monitoring the active fund and the index; and
updating the first active share measure based at least in part on the monitoring of the active fund and the index.

15. The method of claim 14, wherein the updating occurs in real time.

16. The method of claim 10, wherein determining the calibrated fund comprises calculating investment weights associated with two or more securities, wherein the investment weights are based at least in part on a ratio of the first target level of activity and the first active share measure.

17. The method of claim 10, further comprising:
receiving fee data comprising an active fee and a passive fee; and
determining a fee associated with the calibrated fund based at least in part on a weighted average of the active fee and the passive fee.

18. A method of applying fees for active investment, comprising:
monitoring data associated with an active fund and one or more indices;
determining a first active share measure of the active fund relative to a first index of the one or more indices;
receiving fee data comprising an active fee and a passive fee; and
calculating a fee for the active fund based at least in part on the active fee, the passive fee, and the first active share measure.

19. The method of claim 18, further comprising:
determining a plurality of active share measures for the active fund relative to each of a plurality of the one or more indices; and
selecting the first index from among the plurality of the one or more indices based at least in part on the plurality of active share measures.

20. The method of claim 18, further comprising:
redetermining the active share measure in real time based on changes in the monitored data; and
recalculating the fee based at least in part on the redetermined active share measure.
